(19) United States
(12) Patent Application Publication
(10) Pub. No.: US 2025/0102190 A1
(43) Pub. Date: Mar. 27, 2025

(54) Thermal Storage

(71) Applicant: Exowatt, Inc., Miami, FL (US)

(72) Inventors: Kiran Kambly, Miami, FL (US); Sushrut Bapat, Miami, FL (US); Pedro Neves, Miami, FL (US); Ehsan Ordouie, Miami, FL (US); Hannan Parvizian, Miami, FL (US); John M. DeLappe, Miami, FL (US); Christopher Rengifo, Miami, FL (US); Simon Shuham, Miami, FL (US)

(21) Appl. No.: 18/900,274

(22) Filed: Sep. 27, 2024

Related U.S. Application Data
(60) Provisional application No. 63/585,814, filed on Sep. 27, 2023.

(51) Int. Cl. F24S 60/00; F24S 10/70; F24S 23/30; F24S 80/60

(52) U.S. Cl. CPC F24S 60/00; F24S 10/72; F24S 23/31; F24S 80/60

(57) ABSTRACT

A solar energy collection system comprising: a plurality of tracked Fresnel lens arrays; a corresponding plurality of thermal cells positioned to receive solar energy focused by the respective plurality of tracked Fresnel lens arrays; and a working fluid circulation system that circulates a working fluid through the plurality of thermal cells to a discharge point. The discharge point comprises a power conversion unit such as a thermal engine and generator.

### CROSS-REFERENCE TO RELATED APPLICATIONS

Benefit is claimed from U.S. provisional application No. 63/585,814 filed Sep. 27, 2023 and U.S. patent application No. 63/692,688 filed Sep. 9, 2024, the entire contents of each which is incorporated by reference as if expressly set forth.
This application is related to the following copending applications each of which is incorporated herein by reference:
“Thermal Battery Pack” (Attorney Docket No. 8839-27), application No. 63/692,681 filed Sep. 9, 2024 (“Thermal Battery Pack”);
“Thermal Battery Pack Recirculating Housing” (Attorney Docket No. 8839-28), application No. 63/692,684 filed Sep. 9, 2024 (“Thermal Battery Pack Recirculating Housing”);
“Solar Collection Platform” (Attorney Docket No. 8839-30), application No. 63/692,686 filed Sep. 9, 2024 (“Solar Collection Platform”);
“Multi-Drive Fresnel Lens Trackers for Sequential Heat Collection” (Attorney Docket No. 8839-24), application No. 63/692,663 filed Sep. 9, 2024 (“Multi-Drive Fresnel Lens Trackers”).

### FIELD

The technology herein relates to storage of thermal energy including but not limited to storage of thermal energy from solar collectors.

### BACKGROUND & SUMMARY

As “clean” energy solutions are more in demand, some are developing and using solar thermal collectors that collect heat from the sun's rays. But unlike a furnace or boiler that can activate and operate on demand, a solar thermal collector collects heat only when it is exposed to the sun's rays. Little or no heat is collected between sunset and sunrise, or when clouds and weather such as rainy days interfere with solar collection. Thus, the amount of solar thermal energy that can be collected may be impacted by the time of day, the season, the weather and other factors. Meanwhile however, many typical loads such as building heating systems, electrical generators and the like may require energy during periods when the solar thermal collector is collecting little or no energy.

A solution is to store thermal energy during times when the solar thermal collector is collecting thermal energy, and to use the stored thermal energy during times when the solar thermal collector is not collecting enough energy to meet the demand of the load(s). For this reason, thermal energy storage (TES) or thermal batteries have become a valuable area of technological development.

Many different technologies have been used to store thermal energy, including molten salt, steam, molten aluminum, hot silicon or sand, miscibility gap alloys, and many others. See e.g., Gil et al, “State of the art on high temperature thermal energy storage for power generation” published in Renewable and Sustainable Energy Reviews Volume 14, Issue 1, January 2010, Pages 31-72; Parameshwaran et al, Sustainable thermal energy storage technologies for buildings: A review, Renewable and Sustainable Energy Reviews Volume 16, Issue 5, June 2012, Pages 2394-2433; Bauer et al, Thermal Energy Storage Materials And Systems, Annual Review of Heat Transfer (2012) pages 131-177 DOI: 10.1615/AnnualRevHeatTransfer.2012004651.

While much work has been done in the past, further improvements are possible and desirable. In particular, what is needed is a compact, rugged, cost-effective thermal storage that can be deployed as part of an outdoor solar thermal collection facility.

### BRIEF DESCRIPTION OF THE DRAWINGS

FIGS. 1A, 1B show respective views of a thermal storage and thermal engine system.

FIG. 2 shows an example thermal battery within an insulative housing.

FIGS. 3A, 3B, 3C, 3D are respective block diagrams showing passages through a thermal block.

FIG. 4 is a block diagram of an example stacked thermal battery or storage system.

FIG. 5 shows an example partial cutaway view of a modular thermal storage.

FIGS. 6A, 6B, 6C show different views of a further thermal storage embodiment.

### DETAILED DESCRIPTION OF NON-LIMITING EMBODIMENTS

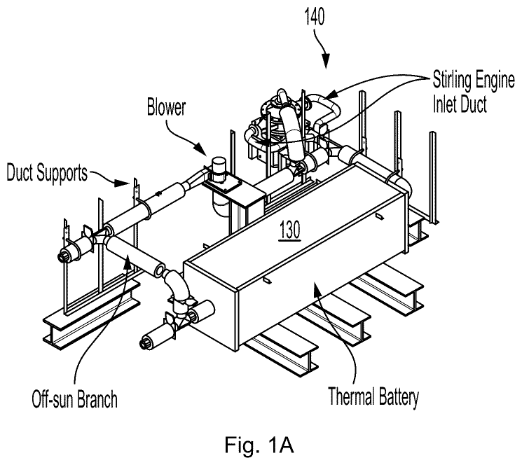

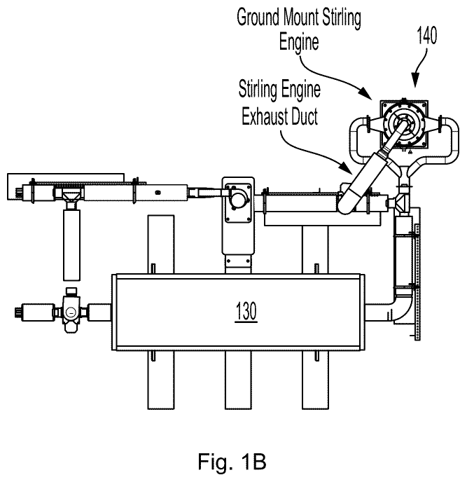

FIGS. 1A-1B show an example thermal storage 130 coupled to a thermal engine 140 such as a Stirling engine. In this example, the thermal storage 130 can store thermal energy for later use (e.g., when clouds obscure the sun and/or after dark and before sunrise, or for longer periods of time). Ducting and a blower can be used to transfer thermal energy from the thermal storage 130 to a conventional thermal engine 140. The thermal storage or battery 130 can be any size and shape and have any number of inlets and outlets.

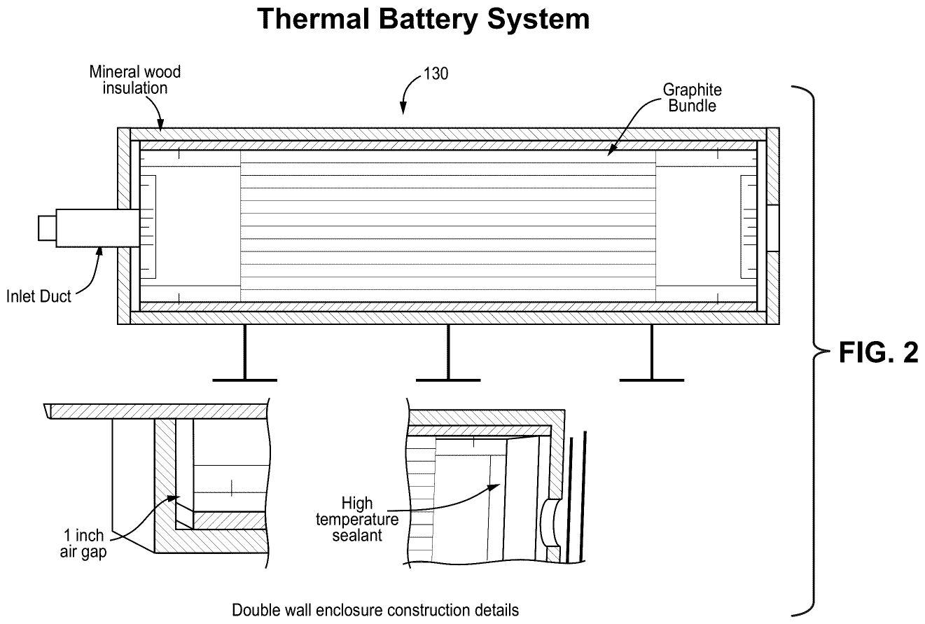

FIG. 2 shows an example thermal battery system 130 comprising a heat retaining mass disposed within an insulated housing or enclosure. Double wall construction, air gaps, mineral wool insulation and high temperature sealant may be used to thermally isolate the mass to minimize heat loss. Inlet and outlet ducts are used to circulate the transport medium through the thermal mass to add heat to and remove heat from the mass. A processor-based control system, thermal sensors and a pump or blower may be used to automatically control the rate at which the transport medium circulates.

In one embodiment, the heat retaining mass may comprise or consist of graphite. Graphite is a crystalline form of carbon (C) that comprises stacked layers of graphene. Thermal properties are strongly influenced by the anisotropy of the graphite crystal. Graphite is generally impossible to melt—that it, it can be heated to very high temperatures without entering the liquid state. This makes graphite a good candidate for storing heat. Graphite also has good heat transfer properties and high thermal conductivity with a low coefficient of thermal expansion—meaning it can be heated to very high temperatures without expanding much.

The present technology is not limited to graphite. In other embodiments, the mass may comprise or consist of other materials or mixtures of materials such as Cordierite, Silicon Carbide, or other silica-based thermal mass, clay, rock, sand, brick, and/or other materials.

In the example shown, the heat-retaining mass can be housed within a thermally insulative housing and isolated from the housing and the outer environment by insulative housing walls (e.g., double wall construction with air gaps between), air gaps between the thermal mass and the housing inner wall, mineral wool or other insulation, high temperature sealant and other such measures. This allows the heat retaining mass to retain very large quantities of heat for relatively long periods of time. Heat retained by the mass can be output to the Stirling engine, to another thermal storage, or any other thermal load.

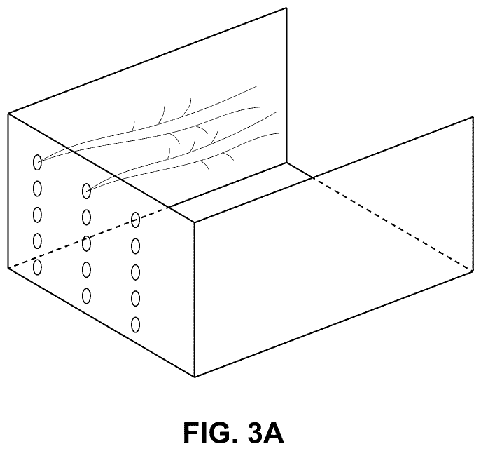

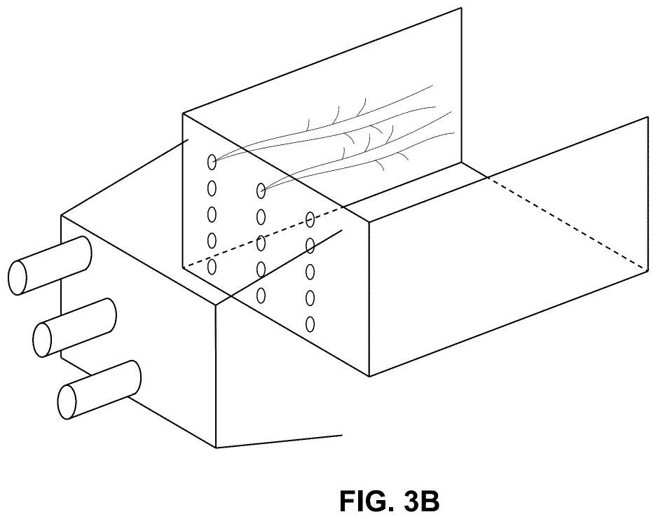

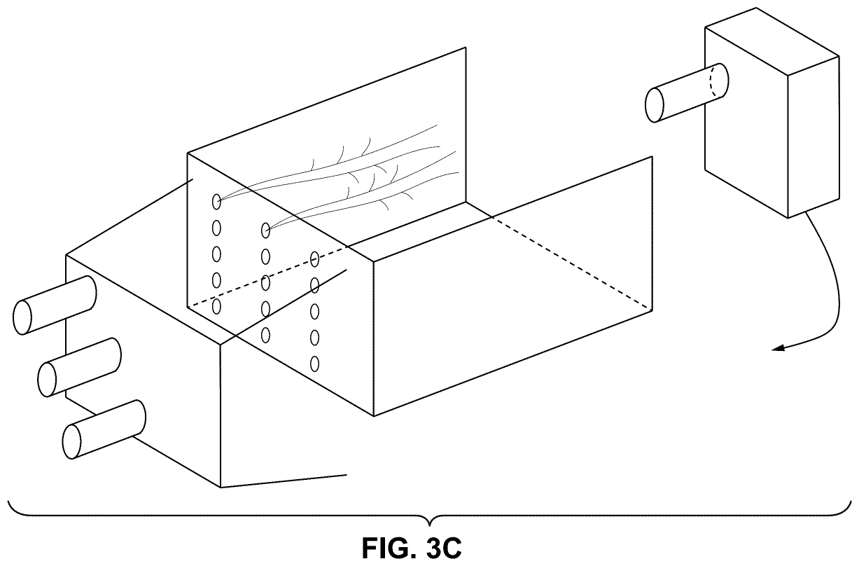

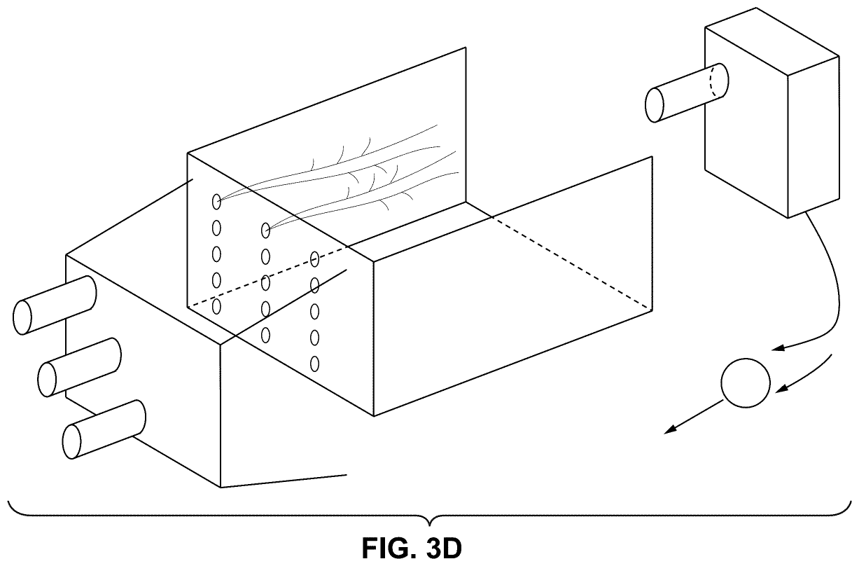

FIG. 3A shows that in one example embodiment, the heat retaining mass may comprise a compression-molded block of thermal mass shaped for example as a cube or rectangular prism. In other embodiments as shown in FIG. 2, the mass can comprise a bundle of rods or tubes rather than a solid block. One example dimension of the block is 4 feet×4 feet or 5 feet×5 feet in cross-section with a length of 6 feet or 7 feet or 8 feet or 9 feet or 10 feet or 11 feet or 12 feet or more than 12 feet. The particular dimensions may vary depending on desired thermal storage capacity.

In one embodiment, passages may be disposed through the block. These passages through the block may communicate with pipes or ducts that carry a heated medium such as a heated gas (for example air, CO2, Helium, or any other suitable gas) or liquid. Coatings or other features of the block may be used to increase heat retention and/or transfer efficiency. Multiple blocks or thermal storage units can be “stacked” (e.g., connected together in series and/or in parallel) to increase thermal capacity. In such stacks, a common circulation system can be used to circulate heat from thermal source to a first mass, from the first mass to a second mass, from the second mass to a third mass, and so on, to one or any number of thermal loads.

For example, FIGS. 3B, 3C, 3D show multiple pipes or ducts in the form of a plenum or manifold that may deliver heat derived from one or multiple sources such as one or multiple solar thermal collectors. The plenum or manifold shown may distribute heat uniformly across the block to prevent cracking or other uneven heating effects. A single outlet on the other side of the block may be used to deliver heat to a thermal load such as a Stirling engine. A medium pump such as a gas blower may be used to transport heat into and out of the block. In one embodiment, the heated medium can be recirculated through the block to add heat to or remove heat from the block. FIGS. 3C, 3D show heat recirculation of the medium through the block and the Stirling or other thermal engine. Branches in the ducts or pipes may be used to route heated gas or other flowing media through the Stirling engine or other thermal load, or to bypass the Stirling engine or other thermal load. The gas or other medium will in some embodiments still be very hot after passing through the Stirling engine or other thermal load, so it is advantageous to recirculate the still-hot medium through the block (and in some embodiments, through the thermal collectors or other thermal sources) repeatedly to avoid wasting thermal energy and to avoid expelling such thermal energy into the environment.

### Example Modular Storage

Other example embodiments provide a thermal battery pack comprising multiple individual battery cells, each of them containing a heat collection, storage and discharge section. The heat collection may comprise for example a Fresnel lens setup with that concentrates energy through apertures for each individual battery cell, towards a receiver surface defined in each such cell. The receiver surface is placed directly on top of the storage to allow for direct heat storage. Heat storage is achieved by sensible heat mechanism and can be a solid media, packed bed or a combination of both. The storage media contains a discharge zone where a finned heat exchanger is integrated to allow for convective discharge. Also contained in the battery cell is a zone for grid charging. The battery pack combines multiple cells, houses ducts and manifolds, and a blower to deliver high-temperature hot-air. Modularized battery cells thus provide for heat collection, storage and discharge, reduced auxiliary loads, to directly capture heat in the storage medium without any need for an intermediate heat exchanger.

A solar energy collection system comprising: a plurality of tracked Fresnel lens arrays; a corresponding plurality of thermal cells positioned to receive solar energy focused by the respective plurality of tracked Fresnel lens arrays; and a working fluid circulation system that circulates a working fluid through the plurality of thermal cells to a discharge point. The discharge point comprises a power conversion unit such as a thermal engine and generator.

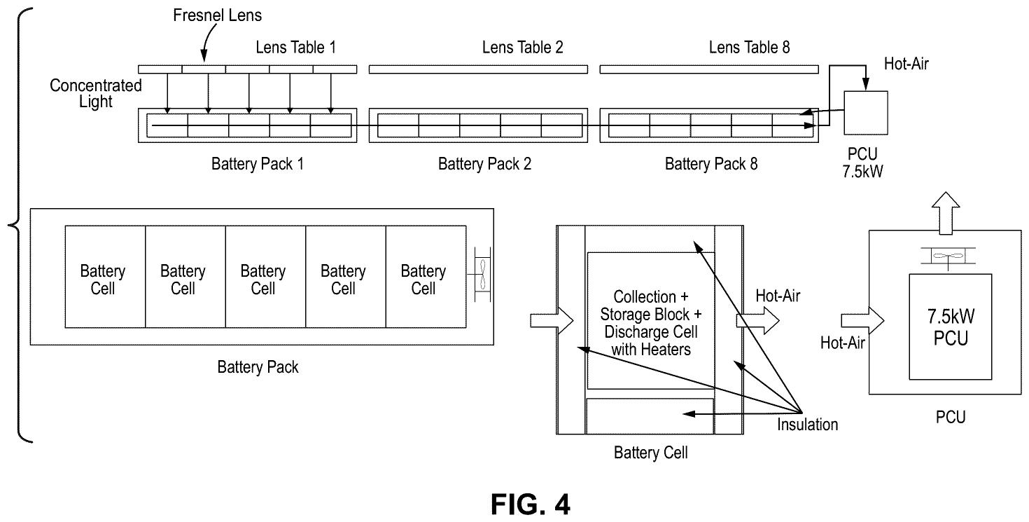

FIG. 4 shows a block diagram of an example embodiment integrating solar heat collection, heat storage and heat discharge by providing a plurality of solar collection platforms (SCPs).

In such arrangement, a plurality of Fresnel lens frames or tables such as described in “Multi-Drive Fresnel Lens Trackers” collect solar energy from the sun and focus the collected energy through apertures defined through battery pack housings as described in “Thermal Battery Pack Recirculating Housing” to impinge on heat receivers of respective thermal cells described in “Thermal Battery Pack” case. Each housing can comprise a battery pack including a plurality of thermal cells. As shown in FIG. 4, any number of battery packs (each of which may be within its own respective insulative housing, thus providing modularity) can be disposed end to end or otherwise “stacked” and coupled together such that a working fluid transport mechanism such as a gas or air blower can commonly circulate gas or air through a series of such battery packs. The battery packs together may progressively heat the working fluid to progressively higher temperatures for discharging and delivering to a thermal load such as a thermal or Stirling engine.

In the example shown, eight (8) such solar collection platforms (SCPs) (each comprising a single-axis multi-drive Fresnel lens array carrying 5 Fresnel lenses, and a thermal housing containing a corresponding number of thermal battery cells (one for each Fresnel lens) can connected end to end to provide common hot air circulation through a power conversion unit (PCU) such as a 7.5 KW Stirling engine with integral electrical generator.

The modular design provides flexibility. For example, a smaller number of SCPs can be stacked together to provide a 12-hour solution to thermally power a given thermal load. A greater number of SCPs can be stacked together to provide a 24-hour solution to thermally power the same thermal load. Different SCPs can be used to thermally power different thermal loads. Example embodiments thus at least provide two levels of modularity:
Each SCP module comprises a Fresnel lens array and associated thermal housing providing integrated heat receivers/absorbers and directed coupled heat storage battery packs; and
Each housing and associated battery pack may comprise a number of independent thermal battery cells that are coupled together to provide an overall battery pack.

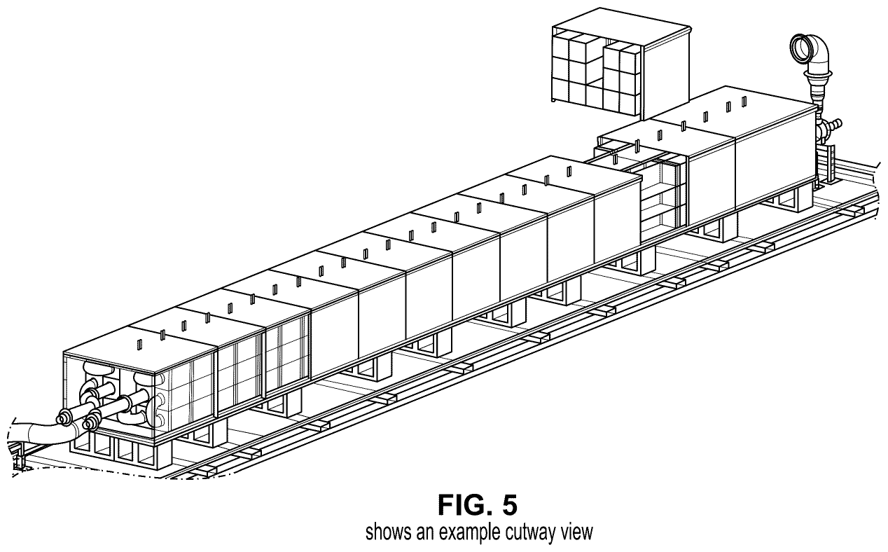

FIG. 5 shows another embodiment of a thermal storage device in modular form. This embodiment includes a number of thermal storage blocks disposed within an elongated insulative housing. The blocks may be of uniform size and be made out of silicon carbide, other silica based materials, or other materials as described above. The individual blocks may be stacked together to provide a higher overall mass thermal storage. The thermal storage can be expanded by adding modules or contracted by removing modules in order to change the heat retention capacity of the thermal storage. Different installations of thermal storage can thus be customized to provide more or less heat storage capacity as needed.

In this example embodiment, the thermal storage comprises stacks of individual blocks or cakes of silicon carbide, clay or other heat retaining material. The blocks have passages defined therethrough to enable heat transport fluid to flow from block to block along the length of the thermal storage. The example shown comprises a stack of blocks three blocks high and four blocks across with a gap in the center forming a radiation chamber for a resistive heater. End piping can be used to enable thermal transport fluid to flow back and forth through passages internal to the thermal storage from one end of the thermal storage to the other. As noted above, different passages can be used for heat input and heat discharge. In the embodiment shown, the heat discharge flow originates and terminates at the same end of the thermal storage, whereas the heat input flow originates at one end of the thermal storage and terminates and the other end of the thermal storage.

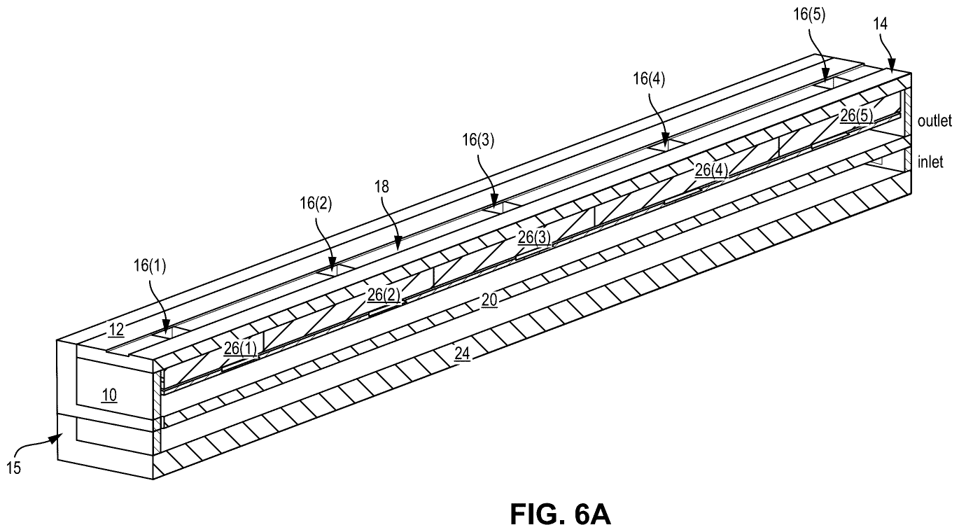

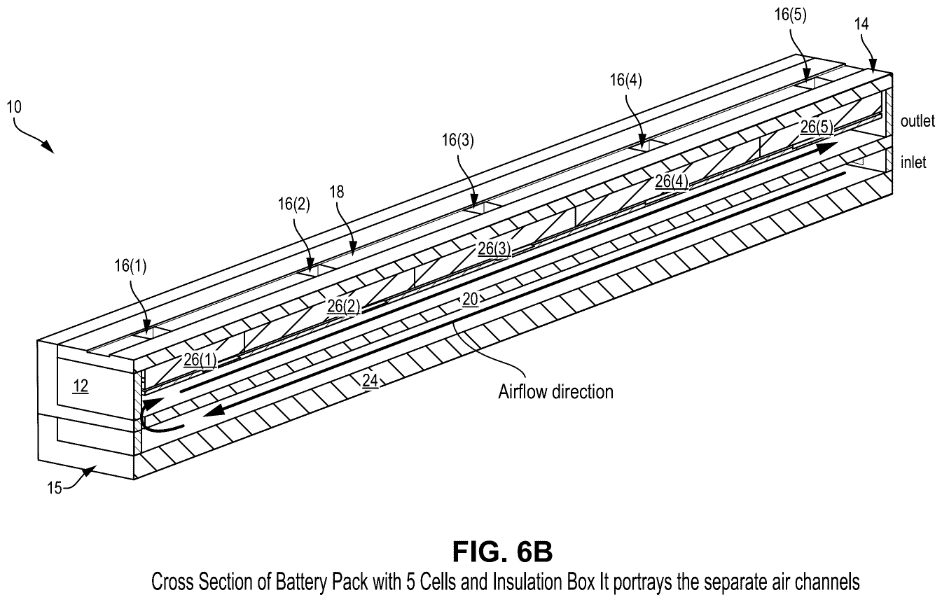

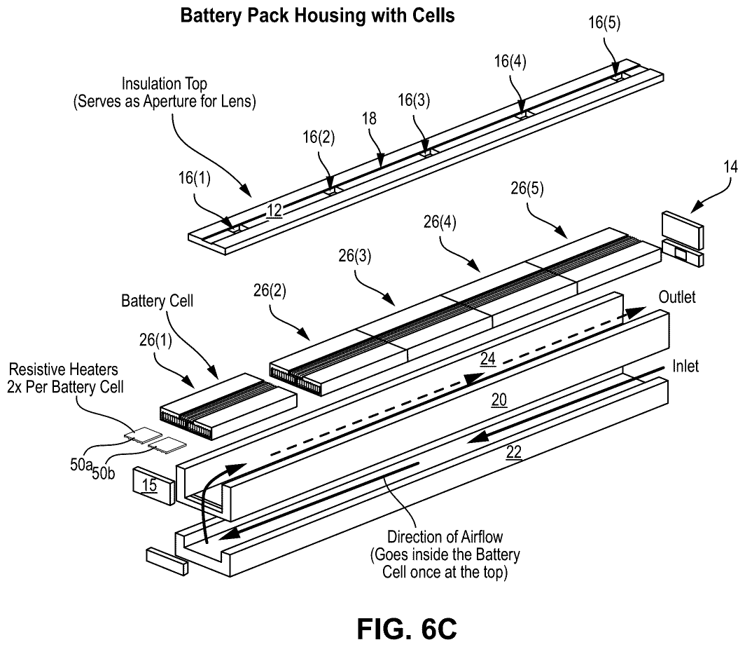

FIGS. 6A, 6B, 6C show yet another embodiment of a stacked thermal storage arrangement. FIG. 6A is a side perspective view of a heat insulative housing 10 for modular heat battery cells. Housing 10 in the embodiment shown is rectangular in shape with planar parallel top, side and bottom surfaces, but other shapes are possible. In the example shown, the length of housing 10 is substantially longer than either the height or the width of the housing, and the height and width of the housing are approximately the same, but other dimensions are possible.

In this embodiment, the rectangular top surface 12 defines, along a longitudinal axis thereof, a series of apertures 16 (square or rectangular openings) spaced along the top surface. The apertures 16 are defined through top surface 12. In this embodiment, the apertures 16 are square but they could be circular or have other shapes. The apertures 16 allow focused heat energy (e.g., as collected and focused by respective Fresnel lenses) to penetrate through the top surface 12 into the interior of housing 10.

The top surface 12 is made of high temperature heat insulative material that will not degrade under high temperatures and will also insulate to cause heat to remain within an interior space(s) within the housing. It has a thickness that will provide a desired heat insulation factor. As shown in exploded FIG. 6C, top surface 12 is defined by a flat grooved plate having the apertures 16 therethrough. In one embodiment, a longitudinal groove runs down the center of the top surface 12 along the length of the top surface, and the apertures 16 are defined within the groove. In one embodiment, the apertures 16 can be shutterable to close the apertures (e.g., by sliding a further insulative plate not shown into groove 18) when no heat from external sources is focused on the apertures (e.g., overnight) in order to further prevent heat from escaping the housing 10—although shutters are not necessary for operation and need not be installed.

Housing 10 further comprises a two-piece channeled lower portion best seen in the FIG. 6C exploded view, comprising a center trough-shaped plate 20 and a lower trough-shaped plate 22. The center trough-shaped plate 20 has a deep longitudinal channel 24 dimensioned to accept and accommodate thermal storage battery cells 26 and position the storage cells in registration with the apertures 16. For example, cell 26(1) is positioned in registry with aperture 16(1), cell 26(2) is positioned in registry with aperture 16(2), and so on. Heat passing through apertures 16 directly impinge on respective heat storage cells 26. In some example embodiments, the cells 26 are themselves channeled to allow air to circulate and flow through the heat storage cells, thereby transporting heat from the cells to a heat load such as a thermal engine. In other example embodiments, the heat storage cells 26 release heat as air flows past them through an air flow channel (best seen in FIG. 2) defined by the center trough-shaped plate. The center trough-shaped plate 20 enables and supports such air flow, as shown in FIG. 6B. For more details concerning example heat storage cells 26, see the two above-cited copending commonly-assigned patent applications.

Also as shown in FIG. 6C, each heat storage cell 26 may accept one or a plurality of resistive electrical heating elements 50a, 50b. These resistive electrical heating elements 50 may produce heat when electricity is applied to them. This capability allows the system to continue to function under low light conditions such as between sunset and sunrise.

As shown in FIG. 6B, housing 10 thus provides circulation of air flow from a cooler air inlet (not shown) at end 14 along the length of the housing through the lower trough 24 to end 15, then upward into the upper trough 20 and back along the length of the housing to a hot air outlet (not shown) at end 14. In example embodiments, end plate 15 acts as a reversing baffle that reverses the flow of air from lower trough 24 and channels it into upper trough 20 for reverse flow past and/or through the thermal battery cells 26 to a hot air outlet.

All patents and publications cited herein are incorporated by reference as if expressly set forth.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A thermal storage comprising:
an insulative housing;
at least one thermal storage block disposed within the insulative housing; and
at least one passage defined through the at least one thermal storage block to allow a heat medium to circulate through the at least one thermal storage block.

2. The thermal storage of claim 1 wherein the at least one thermal storage block comprises an array of thermal storage blocks stacked onto and next to one another.

3. The thermal storage of claim 1 wherein the at least one thermal storage block comprises silicon carbide.

4. The thermal storage of claim 1 wherein the insulative housing comprises a double walled housing.

5. The thermal storage of claim 1 wherein the insulative housing is modular.

6. The thermal storage of claim 1 wherein the at least one passage includes an inlet port at a first end of the insulative housing and an exit port also at the first end of the insulative housing.

7. The thermal storage of claim 1 further including at least one electrical heating element disposed within the insulative housing.

8. The thermal storage of claim 1 wherein the at least one thermal storage block comprises a rod bundle.

9. The thermal storage of claim 1 wherein the at least one passage is configured to flow air therethrough.

10. The thermal storage of claim 1 wherein the insulative housing defines a non-contact air gap between the housing and the at least one thermal storage block.

11. The thermal storage of claim 1 wherein the at least one thermal storage block is configured to absorb, along a longitudinal dimension thereof, heat provided by plural spaced-apart thermal concentrators.

12. The thermal storage of claim 11 wherein the plural spaced-apart thermal concentrators comprise solar concentrators.

13. The thermal storage of claim 12 wherein the solar concentrators comprise Fresnel lenses.

14. The thermal storage of claim 1 further including an electronic controller that controls forced circulation of a heat carrying medium through the at least one passage.
